(19) United States
(12) Patent Application Publication
(10) Pub. No.: US 2022/0119694 A1
(43) Pub. Date: Apr. 21, 2022

(54) HEAT TRANSFER PROCESS

(71) Applicant: ARKEMA FRANCE, Colombes (FR)

(72) Inventors: Wissam RACHED, Chaponost (FR); Laurent ABBAS, Narbeth, PA (US); Jean-Christophe BOUTIER, Oullins (FR)

(73) Assignee: ARKEMA FRANCE, Colombes (FR)

(21) Appl. No.: 17/332,261

(22) Filed: May 27, 2021

Related U.S. Application Data
(63) Continuation of application No. 16/027,602, filed on Jul. 5, 2018, now abandoned.
Application No. 16/027,602 is a continuation of application No. 13/386,701, filed on Jan. 24, 2012, now abandoned.

(30) Foreign Application Priority Data
Jul. 28, 2009 (FR) 0955261

(51) Int. Cl. C09K 5/04

(52) U.S. Cl. CPC C09K 5/045; C10N 2020/06; C09K 2205/11; C09K 2205/112; C09K 2205/12; C09K 2205/122; C09K 2205/126; C10M 2201/062; C10M 2201/103; C10M 2203/022; C10M 2203/065; C10M 2205/0285; C10M 2209/043; C10M 2209/1023; C10M 2209/1033; C10M 2211/022; C09K 2205/106

(57) ABSTRACT

A heat transfer process using a composition containing hydro(chloro)fluoroolefins. A heat transfer process that successively includes a step of evaporation of a refrigerant, a step of compression, a step of condensation of said refrigerant at a temperature greater than or equal to 70° C. and a step of expansion of said refrigerant characterized in that the refrigerant includes at least one hydrofluoroolefin having at least four carbon atoms represented by the formula (I) R¹CH═CHR² in which R¹ and R² independently represent alkyl groups having from 1 to 6 carbon atoms, substituted with at least one fluorine atom, optionally with at least one chlorine atom.

### CROSS REFRENCE TO RELATED APPLICATIONS

The present application is a continuation of U.S. application Ser. No. 16/027,602, filed on Jul. 5, 2018, which is a continuation of U.S. application Ser. No. 13/386,701, filed on Jan. 24, 2012, which is a U.S. national stage of International Application No. PCT/FR2010/051279, filed on Jun. 23, 2010, which claims the benefit of French Application No. 0955261, filed on Jul. 28, 2009. The entire contents of each of U.S. application Ser. No. 13/386,701, International Application No. PCT/FR2010/051279, and French Application No. 0955261 are hereby incorporated herein by reference in their entirety.

### TECHNICAL FIELD

The present invention relates to a heat transfer process using a composition containing hydrofluoroolefins. It relates more particularly to the use of a composition containing hydrofluoroolefins in heat pumps.

### BACKGROUND

The problems posed by substances depleting the ozone layer of the atmosphere (having ozone depletion potential, ODP) were discussed in Montreal, where the protocol was signed requiring a reduction of the production and use of chlorofluorocarbons (CFCs). Amendments have been made to this protocol, requiring abandonment of CFCs and extending the controls to other products.

The refrigeration and air conditioning industry has invested heavily in substitutes for these refrigerants.

In the automotive industry, the air conditioning systems for vehicles marketed in many countries have changed over from a chlorofluorocarbon refrigerant (CFC-12) to a hydrofluorocarbon refrigerant (1,1,1,2-tetrafluoroethane: HFC-134a), which is less harmful to the ozone layer. However, with regard to the objectives established by the Kyoto protocol, HFC-134a (GWP=1300) is regarded as having a high warming effect. A fluid's contribution to the greenhouse effect is quantified by a criterion, the global warming potential (GWP), which summarizes the warming effect, taking a reference value of 1 for carbon dioxide.

As carbon dioxide is nontoxic, nonflammable and has a very low GWP, it has been suggested as a refrigerant in air conditioning systems as a replacement for HFC-134a. However, the use of carbon dioxide presents several drawbacks, notably connected with the very high pressure when it is employed as refrigerant in existing equipment and technologies.

Document JP 4110388 describes the use of hydrofluoropropenes of formula C₃HₘFₙ, with m, n representing an integer between 1 and 5 inclusive and m+n=6, as heat transfer fluids, in particular tetrafluoropropene and trifluoropropene.

Document WO 2004/037913 discloses the use of compositions comprising at least one fluoroalkene having three or four carbon atoms, notably pentafluoropropene and tetrafluoropropene, preferably having a GWP of at most 150, as heat transfer fluids.

In document WO 2007/002625, fluorohaloalkenes having from 3 to 6 carbon atoms, notably tetrafluoropropenes, pentafluoropropenes and chlorotrifluoropropenes are described as being usable as heat transfer fluid.

Document WO 2007/053697 describes heat transfer fluids comprising fluoroolefins having at least 5 carbon atoms.

In the area of heat pumps, substitutes for dichlorotetrafluoroethane (HCFC-114), used in conditions of high condensation temperature, have been proposed. Thus, document U.S. Pat. No. 6,814,884 describes a composition comprising 1,1,1,3,3-pentafluorobutane (HFC-365mfc) and at least one compound selected from 1,1,1,2-tetrafluoroethane, pentafluoroethane (HFC-125), 1,1,1,3,3-pentafluoropropane (HFC-245fa) and 1,1,1,2,3,3,3-heptafluoropropane (HFC-227ea). However, these compounds have a high GWP and have very high compression ratios and temperature lapses relative to HCFC-114.

Document US 2009/0049856 describes heat transfer fluids comprising 1,1,1,3,3-pentafluoropropane (HFC-245fa), 1,1,1,2,3,3-hexafluoropropane (HFC-236ea) and tetrafluoroethane (HFC-134a). However, these mixtures have very high temperatures at the condenser inlet (compressor outlet), which means overheating of the mechanical parts and a decrease in overall efficiency of the compressor. Moreover, the critical temperatures of these mixtures (around 110° C.) are below the desired condensation temperature (120 or even 150° C.), so that they cannot be used in high-temperature heat pumps.

### DETAILED DESCRIPTION

The applicant has now discovered that compositions containing hydrofluoroolefins are quite particularly suitable as heat transfer fluid in heat pumps, especially heat pumps operating at high condensation temperature. Moreover, these compositions have a negligible ODP and a GWP less than that of the existing heat transfer fluids. Furthermore, these mixtures have critical temperatures above 150° C., thus permitting their use in high-temperature heat pumps.

A heat pump is a thermodynamic device enabling heat to be transferred from the coldest medium to the hottest medium. The heat pumps employed for heating are said to be of the compression type and operation is based on the principle of a cycle with compression of fluids, called refrigerants. These heat pumps function with compression systems having a single stage or several stages. At a given stage, when the refrigerant is compressed and passes from the gaseous state to the liquid state, an exothermic reaction (condensation) takes place, which produces heat. Conversely, if the fluid is expanded, causing it to pass from the liquid state to the gaseous state, an endothermic reaction (evaporation) takes place, which produces a sensation of cold. Thus, everything is based on the change of state of a fluid used in a closed circuit.

Each stage of a compression system comprises (i) an evaporation step during which, on contact with calories drawn from the environment, the refrigerant, on account of its low boiling point, passes from the two-phase state (liquid/gas) to the gaseous state, (ii) a compression step during which the gas from the preceding step is raised to high pressure, (iii) a condensation step during which the gas will transfer its heat to the heating circuit (hot environment); the refrigerant, still compressed, becomes liquid again and (iv) an expansion step during which the pressure of the fluid is reduced. The fluid is ready for absorbing calories again from the cold environment.

The present invention relates to a heat transfer process using a compression system having at least one stage comprising successively a step of evaporation of a refrigerant, a compression step, a condensation step of said fluid at a temperature greater than or equal to 70° C. and an expansion step of said fluid, characterized in that the refrigerant comprises at least one hydrofluoroolefin having at least 4 carbon atoms represented by formula (I) R¹CH═CHR² in which R¹ and R² represent, independently, alkyl groups having from 1 to 6 carbon atoms, substituted with at least one fluorine atom, optionally with at least one chlorine atom.

Preferably, at least one alkyl group of the hydrofluoroolefin is completely substituted with fluorine atoms.

Preferably, the condensation temperature of the refrigerant is between 70 and 150° C., and advantageously between 95 and 140° C.

As hydrofluoroolefins of formula (I) that are particularly advantageous, mention may notably be made of 1,1,1,4,4,4-hexafluorobut-2-ene, 1,1,1,4,4,5,5,5-octafluoro-pent-2-ene, 1,1,1,4-tetrafluorobut-2-ene, 1,1,1,4,4-pentafluorobut-2-ene, 1,1,4-trifluorobut-2-ene, 1,1,1-trifluorobut-2-ene, 4-chloro-1,1,1-trifluorobut-2-ene, 4-chloro-4,4-difluorobut-2-ene.

The preferred hydrofluoroolefins of formula (I) can be in the cis or trans form or mixture of the two.

Besides the hydrofluoroolefin(s) of formula (I), the refrigerant can comprise at least one compound selected from hydrofluorocarbons, hydrocarbons, (hydro)fluoroethers, hydrochlorofluoropropenes, hydrofluoropropenes, ethers, methyl formate, carbon dioxide and trans-1,2-dichloroethylene.

As hydrofluorocarbons, mention may notably be made of 1,1,1,3,3-pentafluorobutane, 1,1,1,2-tetrafluoroethane, pentafluoroethane, 1,1,1,3,3-pentafluoropropane, 1,1,1,2,3-pentafluoropropane, 1,1,1,2,2-pentafluoropropane, 1,1,1,3,3,3-hexafluoropropane, 1,1,2,2,3-pentafluoropropane, 1,1,1,3,3-pentafluorobutane, 1,1,1,2,2,3,4,5,5,5-decafluoropentane and 1,1,1,2,3,3,3-heptafluoropropane.

Hydrocarbons having at least three carbon atoms are preferred. Hydrocarbons with five carbon atoms such as pentane, isopentane, cyclopentane are particularly preferred.

The preferred hydrochlorofluoropropenes are 2-chloro-3,3,3-trifluoroprop-1-ene, 1-chloro-3,3,3-trifluoroprop-1-ene, in particular trans-1-chloro-3,3,3-trifluoroprop-1-ene.

The preferred hydrofluoroethers are those having from three to six carbon atoms.

As hydrofluoroethers, mention may notably be made of heptafluoromethoxypropane, nonafluoromethoxybutane and nonafluoroethoxybutane. The hydrofluoroether is available in several isomeric forms such as 1,1,1,2,2,3,3,4,4-nonafluoro-ethoxybutane, 1,1,1,2,3,3-hexafluoro-2-(trifluoromethyl)-3-ethoxybutane, 1,1,1,2,2,3,3,4,4-nonafluoro-methoxybutane, 1,1,1,2,3,3-hexafluoro-2-(trifluoromethyl)-3-methoxybutane, and 1,1,1,2,2,3,3-heptafluoromethoxypropane.

The preferred hydrofluoropropenes are trifluoropropenes such as 1,1,1-trifluoropropene, tetrafluoropropenes such as 2,3,3,3-tetrafluoropropene (HFO-1234yf), and 1,3,3,3-tetrafluoropropene (cis and/or trans).

The ethers can be selected from dimethyl ether, diethyl ether, dimethoxymethane or dipropoxymethane.

Preferably, the refrigerant comprises at least one hydrofluoroolefin of formula (I) and at least one hydrofluorocarbon. The hydrofluorocarbon selected is advantageously 1,1,1,3,3-pentafluorobutane and 1,1,1,3,3-pentafluoropropane.

Azeotropic compositions of 1,1,1,4,4,4-hexafluorobut-2-ene or of 1,1,1,4,4,5,5,5-octafluoro-pent-2-ene with methyl formate, pentane, isopentane, cyclopentane or trans-1,2-dichloroethylene may also be suitable.

Preferably, the refrigerant comprises at least 10 wt. % of hydrofluoroolefins of formula (I).

According to one embodiment of the invention, the refrigerant comprises from 40 to 100 wt. % of 1,1,1,4,4,4-hexafluorobut-2-ene and from 0 to 60 wt. % of at least one compound selected from pentane, isopentane, cyclopentane and trans-1,2-dichloroethylene.

As refrigerants that are particularly preferred, mention may be made of those comprising from 60 to 100 wt. % of 1,1,1,4,4,4-hexafluorobut-2-ene and from 0 to 40 wt. % of cyclopentane, pentane, isopentane or trans-1,2-dichloroethylene.

The refrigerant used in the present invention can comprise a stabilizer of the hydrofluoroolefin. The stabilizer represents at most 5 wt. % relative to the total composition of the fluid.

As stabilizers, mention may notably be made of nitromethane, ascorbic acid, terephthalic acid, azoles such as tolutriazole or benzotriazole, phenolic compounds such as tocopherol, hydroquinone, t-butyl hydroquinone, 2,6-di-ter-butyl-4-methylphenol, epoxides (alkyl optionally fluorinated or perfluorinated or alkenyl or aromatic) such as n-butyl glycidyl ether, hexanediol diglycidyl ether, allyl glycidyl ether, butylphenylglycidyl ether, phosphites, phosphates, phosphonates, thiols and lactones.

The refrigerant used in the process according to the present invention can comprise lubricants such as mineral oil, alkylbenzene, polyalfaolefin, polyalkylene glycol, polyol ester and polyvinyl ether. The lubricants used with the refrigerant can comprise nanoparticles for improving the thermal conductivity of the fluid as well as its compatibility with the lubricants. As nanoparticles, mention may notably be made of particles of Al₂O₃ or of TiO₂.

The lubricants used with the refrigerant can comprise dehumidifying agents of the zeolite type. The zeolites absorb water and thus limit corrosion and deterioration of performance.

### Experimental Section

### Hereinafter:

Evap: evaporator,
Cond: condenser,
Temp: temperature,
Comp: compressor,
P: pressure,
Ratio: compression ratio
COP: coefficient of performance, which is defined, for a heat pump, as the ratio of the useful high-temperature power supplied by the system to the power supplied to or consumed by the system
CAP: volumetric capacity, it is the calorific capacity of heating per unit volume (kJ/m3) % CAP or COP is the ratio of the value of CAP or COP of the fluid relative to that obtained with HCFC-114.

### EXAMPLE 1

The performance of the refrigerant in the operating conditions of the heat pump with the temperature at the evaporator maintained at 30° C., at the compressor inlet maintained at 35° C. and at the condenser at 90° C. are given below.

The COP of the various products is calculated as % of the COP of HCFC114 or R114.
Isentropic efficiency of the compressor: 59.3%

C ISOPENTANE

E trans-1,2-dichloroethylene

H pentane

J 1,1,1,4,4,4-hexafluorobut-2-ene

| | | Temp | Temp | Temp | T | | Temp | | | | | | |
|---|---|---|---|---|---|---|---|---|---|---|---|---|---|
| | | evap | evap | comp | cond | T | expand- | evap | cond | | | Effi- | |
| | | inlet | outlet | inlet | inlet | cond | er inlet | P | P | Ratio | | ciency | % |
| | | (° C.) | (° C.) | (° C.) | (° C.) | (° C.) | (° C.) | (bar) | (bar) | (p/p) | Lapse | comp | COP |
| HCFC-114 | | 30 | 30 | 35 | 96 | 90 | 85 | 2.5 | 11.55 | 4.6 | 0.0 | 0.59 | 100 |
| 245fa/236ea/ | | 30 | | 35 | 113 | 90 | 85 | 6.0 | 27.4 | 4.6 | 3.28 | 0.59 | 99 |
| 134a (10/10/ | | | | | | | | | | | | | |
| 80 wt. %) | | | | | | | | | | | | | |
| 365mfc/227ea | | 25 | 30 | 35 | 104 | 90 | 85 | 0.9 | 7.89 | 9.1 | 4.8 | 0.59 | 90 |
| (75/25 wt. %) | | | | | | | | | | | | | |
| J | | 30 | 30 | 35 | 92 | 90 | 85 | 0.9 | 5.58 | 6.2 | 0.0 | 0.59 | 104 |
| H | J | | | | | | | | | | | | |
| 5 | 95 | 29 | 30 | 35 | 93 | 90 | 85 | 1.0 | 6.18 | 6.2 | 1.5 | 0.59 | 100 |
| 20 | 80 | 29 | 30 | 35 | 91 | 90 | 85 | 1.2 | 6.78 | 5.5 | 1.4 | 0.59 | 100 |
| 30 | 70 | 30 | 30 | 35 | 90 | 90 | 85 | 1.3 | 6.80 | 5.2 | 0.0 | 0.59 | 102 |
| 40 | 60 | 28 | 30 | 35 | 93 | 90 | 85 | 1.2 | 6.70 | 5.5 | 2.1 | 0.59 | 100 |
| C | J | | | | | | | | | | | | |
| 30 | 70 | 29 | 30 | 35 | 90 | 90 | 85 | 1.5 | 7.49 | 5.2 | 1.0 | 0.59 | 100 |
| 40 | 60 | 30 | 30 | 35 | 90 | 90 | 85 | 1.5 | 7.48 | 5.0 | 0.2 | 0.59 | 101 |
| E | J | | | | | | | | | | | | |
| 5 | 95 | 29 | 30 | 35 | 94 | 90 | 85 | 1.0 | 5.80 | 6.1 | 0.5 | 0.59 | 104 |
| 10 | 90 | 29 | 30 | 35 | 96 | 90 | 85 | 1.0 | 5.94 | 6.0 | 0.7 | 0.59 | 105 |
| 15 | 85 | 29 | 30 | 35 | 98 | 90 | 85 | 1.0 | 6.02 | 5.8 | 0.6 | 0.59 | 106 |
| 20 | 80 | 30 | 30 | 35 | 100 | 90 | 85 | 1.1 | 6.05 | 5.7 | 0.2 | 0.59 | 108 |
| 30 | 70 | 29 | 30 | 35 | 106 | 90 | 85 | 1.0 | 6.02 | 5.8 | 0.8 | 0.59 | 109 |
| 40 | 60 | 26 | 30 | 35 | 117 | 90 | 85 | 0.9 | 5.91 | 6.5 | 4.2 | 0.59 | 106 |

The results show an increase in COP relative to the reference product (R114).

The binary mixtures (H, J) and (C, J) have a COP, a condenser inlet temperature and a compression ratio equivalent to the value of R114 and these products are quasi-azeotropes with values of temperature lapse below 2.2° C.

Product J and the mixtures (E, J) have a COP 5% higher than the COP of the reference product (R114).

### EXAMPLE 2

The performance of the refrigerant in heat pump operating conditions with temperature at the evaporator maintained at 80° C., at the compressor inlet maintained at 85° C. and at the condenser at 140° C. are given below.

The COP and CAP of the various products are calculated as % of COP and CAP of R114 respectively.

lsentropic efficiency of the compressor: 59.3%

C ISOPENTANE

E trans-1,2-dichloroethylene

H pentane

J 1,1,1,4,4,4-hexafluorobut-2-ene

| | | Temp | Temp | Temp | T | | Temp | | | | | | | |
|---|---|---|---|---|---|---|---|---|---|---|---|---|---|---|
| | | evap | evap | comp | cond | T | expand- | evap | cond | | | Effi- | | |
| | | inlet | outlet | inlet | inlet | cond | er inlet | P | P | Ratio | | ciency | % | % |
| | | (° C.) | (° C.) | (° C.) | (° C.) | (° C.) | (° C.) | (bar) | (bar) | (p/p) | Lapse | comp | CAP | COP |
| HCFC-R114 | | 80 | 80 | 85 | 148 | 140 | 135 | 9.3 | 29.6 | 3.2 | 0.0 | 0.59 | 100 | 100 |
| 245fa | | 80 | 80 | 85 | 147 | 140 | 135 | 7.9 | 28.6 | 3.6 | 0.0 | 0.59 | 114 | 118 |
| 365mfc | | 80 | 80 | 85 | 140 | 140 | 135 | 3.5 | 14.1 | 4.0 | 0.0 | 0.59 | 71 | 151 |
| 365mfc/227 ea | | 77 | 80 | 85 | 148 | 140 | 135 | 4.3 | 20.7 | 4.8 | 3.1 | 0.59 | 79 | 123 |
| (75/25 wt. %) | | | | | | | | | | | | | | |
| J | | 80 | 80 | 85 | 140 | 140 | 135 | 4.3 | 16.6 | 3.8 | 0.0 | 0.59 | 81 | 146 |
| H | J | | | | | | | | | | | | | |
| 5 | 95 | 79 | 80 | 85 | 140 | 140 | 135 | 4.6 | 17.4 | 3.8 | 0.7 | 0.59 | 82 | 141 |
| 10 | 90 | 79 | 80 | 85 | 140 | 140 | 135 | 4.9 | 18.0 | 3.7 | 0.9 | 0.59 | 83 | 137 |
| 15 | 85 | 79 | 80 | 85 | 140 | 140 | 135 | 5.2 | 18.3 | 3.5 | 0.7 | 0.59 | 84 | 136 |
| 20 | 80 | 80 | 80 | 85 | 140 | 140 | 135 | 5.3 | 18.4 | 3.5 | 0.3 | 0.59 | 85 | 136 |
| 30 | 70 | 80 | 80 | 85 | 140 | 140 | 135 | 5.4 | 18.3 | 3.4 | 0.1 | 0.59 | 85 | 137 |
| 40 | 60 | 79 | 80 | 85 | 141 | 140 | 135 | 5.1 | 17.9 | 3.5 | 1.2 | 0.59 | 83 | 136 |
| C | J | | | | | | | | | | | | | |
| 5 | 95 | 79 | 80 | 85 | 141 | 140 | 135 | 4.7 | 17.8 | 3.8 | 0.9 | 0.59 | 82 | 138 |
| 10 | 90 | 79 | 80 | 85 | 141 | 140 | 135 | 5.0 | 18.7 | 3.7 | 1.3 | 0.59 | 83 | 134 |
| 15 | 85 | 79 | 80 | 85 | 141 | 140 | 135 | 5.3 | 19.3 | 3.6 | 1.4 | 0.59 | 85 | 131 |
| 20 | 80 | 79 | 80 | 85 | 140 | 140 | 135 | 5.6 | 19.7 | 3.5 | 1.0 | 0.59 | 86 | 130 |
| 30 | 70 | 80 | 80 | 85 | 140 | 140 | 135 | 6.0 | 19.9 | 3.3 | 0.1 | 0.59 | 87 | 130 |
| 40 | 60 | 80 | 80 | 85 | 140 | 140 | 135 | 5.9 | 19.7 | 3.3 | 0.2 | 0.59 | 87 | 131 |
| E | J | | | | | | | | | | | | | |
| 5 | 95 | 80 | 80 | 85 | 140 | 140 | 135 | 4.5 | 16.8 | 3.8 | 0.2 | 0.59 | 85 | 149 |
| 10 | 90 | 80 | 80 | 85 | 140 | 140 | 135 | 4.6 | 17.0 | 3.7 | 0.2 | 0.59 | 88 | 151 |
| 15 | 85 | 80 | 80 | 85 | 141 | 140 | 135 | 4.7 | 17.1 | 3.6 | 0.2 | 0.59 | 92 | 155 |
| 20 | 80 | 80 | 80 | 85 | 142 | 140 | 135 | 4.8 | 17.1 | 3.6 | 0.0 | 0.59 | 95 | 158 |
| 30 | 70 | 79 | 80 | 85 | 146 | 140 | 135 | 4.6 | 16.9 | 3.6 | 0.6 | 0.59 | 98 | 163 |
| 40 | 60 | 77 | 80 | 85 | 154 | 140 | 135 | 4.2 | 16.5 | 3.9 | 3.2 | 0.59 | 96 | 162 |

The results show that the COP of the new products is far greater than the COP of the reference (R114).

### Embodiments

1. A heat transfer process employing a compression system having at least one stage comprising successively a step of evaporation of a refrigerant, a compression step, a condensation step of said fluid at a temperature greater than or equal to 70° C. and an expansion step of said fluid, characterized in that the refrigerant comprises at least one hydrofluoroolefin having at least 4 carbon atoms represented by the formula R¹CH═CHR² in which R¹ and R² represent, independently, alkyl groups having from 1 to 6 carbon atoms, substituted with at least one fluorine atom, optionally with at least one chlorine atom.

2. The process as in embodiment 1, characterized in that the temperature is between 70 and 150° C., preferably between 95 and 140° C.

3. The process as in embodiment 1 or 2, characterized in that the refrigerant further comprises at least one compound selected from hydrofluorocarbons, hydrocarbons, (hydro)fluoroethers, hydrochlorofluoropropenes, hydrofluoropropenes, ethers, methyl formate, carbon dioxide and trans-1,2-dichloroethylene.

4. The process as in any one of embodiments 1 to 3, characterized in that the refrigerant comprises at least one hydrofluorocarbon selected from 1,1,1,3,3-pentafluorobutane and 1,1,1,3,3-pentafluoropropane.

5. The process as in any one of embodiments 1 to 4, characterized in that the refrigerant comprises at least one hydrocarbon selected from pentane, isopentane and cyclopentane.

6. The process as in any one of embodiments 1 to 5, characterized in that the refrigerant comprises from 40 to 100 wt. % of 1,1,1,4,4,4-hexafluorobut-2-ene and from 0 to 60 wt. % of at least one compound selected from pentane, isopentane, cyclopentane and trans-1,2-dichloroethylene.

7. The process as in any one of embodiments 1 to 6, characterized in that refrigerant comprises from 60 to 100 wt. % of 1,1,1,4,4,4-hexafluorobut-2-ene and from 0 to 40 wt. % of cyclopentane, pentane, isopentane or trans-1,2-dichloroethylene.

8. The process as in any one of embodiments 1 to 7, characterized in that the refrigerant comprises a stabilizer.

9. The process as in any one of embodiments 1 to 8, characterized in that the refrigerant comprises a lubricant.

10. The process as in embodiment 9, characterized in that the lubricant is polyalkylene glycol, polyol ester or polyvinyl ether.

1. A heat transfer process employing a compression system having at least one stage comprising successively a step of evaporation of a refrigerant, a compression step, a condensation step of said fluid at a temperature greater than or equal to 70° C. and an expansion step of said fluid, characterized in that the refrigerant comprises at least one hydrofluoroolefin having at least 4 carbon atoms represented by the formula R¹CH═CHR² in which R¹ and R² represent, independently, alkyl groups having from 1 to 6 carbon atoms, substituted with at least one fluorine atom, optionally with at least one chlorine atom.

2. The process as claimed in claim 1, characterized in that the temperature is between 70 and 150° C., preferably between 95 and 140° C.

3. The process as claimed in claim 1, characterized in that the refrigerant further comprises at least one compound selected from hydrofluorocarbons, hydrocarbons, (hydro)fluoroethers, hydrochlorofluoropropenes, hydrofluoropropenes, ethers, methyl formate, carbon dioxide and trans-1,2-dichloroethylene.

4. The process as claimed in claim 1, characterized in that the refrigerant comprises at least one hydrofluorocarbon selected from 1,1,1,3,3-pentafluorobutane and 1,1,1,3,3-pentafluoropropane.

5. The process as claimed in claim 1, characterized in that the refrigerant comprises at least one hydrocarbon selected from pentane, isopentane and cyclopentane.

6. The process as claimed in claim 1, characterized in that the refrigerant comprises from 40 to 100 wt. % of 1,1,1,4,4,4-hexafluorobut-2-ene and from 0 to 60 wt. % of at least one compound selected from pentane, isopentane, cyclopentane and trans-1,2-dichloroethylene.

7. The process as claimed in claim 1, characterized in that refrigerant comprises from 60 to 100 wt. % of 1,1,1,4,4,4-hexafluorobut-2-ene and from 0 to 40 wt. % of cyclopentane, pentane, isopentane or trans-1,2-dichloroethylene.

8. The process as claimed in claim 1 characterized in that the refrigerant comprises a stabilizer.

9. The process as claimed in claim 1, characterized in that the refrigerant comprises a lubricant.

10. The process as claimed in claim 9, characterized in that the lubricant is polyalkylene glycol, polyol ester or polyvinyl ether.
